(19) United States
(12) Patent Application Publication
(10) Pub. No.: US 2024/0193450 A1
(43) Pub. Date: Jun. 13, 2024

(54) Classical Preprocessing for Efficient State Preparation in Quantum Computers

(71) Applicant: Classiq Technologies LTD., Tel Aviv (IL)

(72) Inventors: Amir Naveh, Haifa (GB); Shmuel Ur, Shorashim (IL); Tal Goren, Kibbutz Nahsholim (IL); Adam Goldfeld, Kiryat Motzkin (IL); Eyal Cornfeld, Ramat Gan (IL); Ofek Kirzner, Haifa (IL); Nir Minerbi, Haifa (IL)

(21) Appl. No.: 18/064,273

(22) Filed: Dec. 11, 2022

(51) Int. Cl. G06N 10/20; G06F 9/50; G06N 10/40

(52) U.S. Cl. CPC G06N 10/20; G06F 9/5005; G06N 10/40

(57) ABSTRACT

A method, apparatus, and product comprising: computing, using a classical computer, a modified quantum state based on an application of a transformation on an initial quantum state, the initial quantum state is associated with one or more qubits, a quantum circuit comprising the one or more qubits, and an original sub-circuit that is configured to set the initial quantum state on the one or more qubits; and generating a modified quantum circuit that comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles.

### TECHNICAL FIELD

The present disclosure relates to quantum computing in general, and to generating an efficient quantum circuit, in particular.

### BACKGROUND

Quantum computing is a computational paradigm that is fundamentally different from classical computing. In contrast to classical computing, which utilizes bits, quantum computing utilizes qubits. The qubits have unique features, as each qubit can be in superposition, several qubits can be entangled, and all operations on qubits besides measurement, referred to as quantum gates, must be reversible. Temporarily computed values are stored on additional helper qubits, referred to as auxiliary qubits.

A qubit is the physical carrier of quantum information, which is referred to as the ‘quantum state’ of the qubit. Qubits use the quantum mechanical phenomena of superposition to achieve a linear combination of two states. For example, a qubit can represent a state of value zero, a state of value one, or any proportion between the values one and zero in superposition of both states.

### BRIEF SUMMARY

One exemplary embodiment of the disclosed subject matter is a method comprising: computing, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits; and generating a modified quantum circuit based on the quantum circuit, the modified quantum circuit is configured to be executed by a quantum computer, the modified quantum circuit comprising the one or more qubits, wherein the modified quantum circuit excludes the original sub-circuit, wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.

Optionally, said computing the modified quantum state comprises: applying the transformation on the initial quantum state, to thereby obtain a transformed quantum state; and compressing the transformed quantum state to obtain the modified quantum state.

Optionally, the transformed quantum state is represented by a set of coefficients in a state base, and said compressing comprises removing one or more coefficients from the set of coefficients, whereby the inverse transformation enables to provide a partial reconstruction of the initial quantum state and not a full reconstruction of the initial quantum state.

Optionally, the one or more coefficients are selected to be removed by said compressing based on a determination that the one or more coefficients are insignificant.

Optionally, the method comprises selecting the transformation from a set of potential transformations, wherein said selecting is performed based on at least one of: a first amount of quantum resources required for setting the modified quantum state on the one or more qubits, and a second amount of quantum resources required for applying the inverse transformation on the one or more qubits at one or more subsequent cycles of the modified quantum circuit.

Optionally, execution of the quantum circuit utilizes a quantum resource, and execution of the modified quantum circuit does not utilize the quantum resource.

Optionally, said generating the modified quantum circuit comprises setting the modified quantum state on the one or more qubits using one or more quantum state setters.

Optionally, the modified quantum state comprises a scarce representation of the initial quantum state.

Optionally, the initial quantum state is represented by a first set of coefficients over a first state base, and the scarce representation utilizes a second set of coefficients over a second state base, wherein the first set of coefficients comprises a greater number of coefficients than the second set of coefficients.

Optionally, the method comprises executing, by the quantum computer, the modified quantum circuit.

Optionally, the method comprises determining the initial quantum state, wherein the initial quantum state is determined by executing the quantum circuit or a representation thereof.

Another exemplary embodiment of the disclosed subject matter is an apparatus comprising a processor and coupled memory, said processor being adapted to: compute, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits, and generate a modified quantum circuit based on the quantum circuit, the modified quantum circuit is configured to be executed by a quantum computer, the modified quantum circuit comprising the one or more qubits, wherein the modified quantum circuit excludes the original sub-circuit, wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.

Yet another exemplary embodiment of the disclosed subject matter is a system comprising a processor and coupled memory, said processor being adapted to: compute, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits; and generate a modified quantum circuit based on the quantum circuit, the modified quantum circuit is configured to be executed by a quantum computer, the modified quantum circuit comprising the one or more qubits, wherein the modified quantum circuit excludes the original sub-circuit, wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.

Yet another exemplary embodiment of the disclosed subject matter is a computer program product comprising a non-transitory computer readable medium retaining program instructions, which program instructions when read by a processor, cause the processor to: compute, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits; and generate a modified quantum circuit based on the quantum circuit, the modified quantum circuit is configured to be executed by a quantum computer, the modified quantum circuit comprising the one or more qubits, wherein the modified quantum circuit excludes the original sub-circuit, wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 depicts an exemplary flowchart diagram of a method, in accordance with some exemplary embodiments of the disclosed subject matter:

FIGS. 2A-2C depict exemplary quantum circuits, in accordance with some exemplary embodiments of the disclosed subject matter;

FIGS. 3A-3E depict exemplary quantum and classical computations, in accordance with some exemplary embodiments of the disclosed subject matter; and

FIG. 4 depicts an exemplary block diagram of an apparatus, in accordance with some exemplary embodiments of the disclosed subject matter.

### DETAILED DESCRIPTION

One technical problem dealt with by the disclosed subject matter is to reduce a number of resources that are used for executing a quantum circuit. In some exemplary embodiments, quantum circuits may be designed, programmed or created by a user, a programmer, an operator, or the like, using gate-level programming, using functional-level code, using high-level programming language, using evolutionary computing techniques such as Quantum Genetic Algorithm (QGA), using genetic algorithms, or the like. In some exemplary embodiments, after an initial quantum circuit is created, it may go through one or more stages, such as a compilation stage, before becoming an executable quantum circuit. In some exemplary embodiments, the executable quantum circuit may comprise a machine representation that can be executed by a quantum hardware compiler, a logical program circuit that can be simulated by a classical computer or engine, or the like. In some exemplary embodiments, executing a quantum circuit may utilize resources, such as time resources, quantum gate resources, qubit resources, cycle resources, or the like. It may be desired to execute a quantum circuit while reducing the resources that are used, one or more types thereof, or the like, while ensuring that the functionality of the quantum circuit is maintained. In some cases, the quantity of resources may relate to one or more weighted or non-weighted combinations of resources, defining a desired tradeoff between resources. For example, it may be beneficial to reduce one type of resource even at the expense of another. As another example, it may be desired to reduce the quantum resource utilization without increasing the error rate, without increasing the error rate more than a threshold, or the like.

Another technical problem dealt with by the disclosed subject matter is to prepare (also referred to as ‘load’, ‘apply’, or ‘set’) states of qubits in a resource conserving manner. In some exemplary embodiments, a quantum circuit may be wired or connected to multiple qubits, such as input qubits that constitute the logical input to the quantum circuit, auxiliary qubits that are not be part of a quantum function logic flow, or the like. In some exemplary embodiments, in order for the quantum circuit to implement a desired functionality, the quantum circuit may prepare the initial states of all or some of the qubits in one or more initial states. In some cases, the initial states may be obtained from a user, obtained from another computer, generated randomly, or the like. For example, in case a quantum circuit is configured to sum a state of a first qubit A with a state of a second qubit B and provide the summed states via a third qubit C, the initial states of qubits A and B may comprise the states that the user wishes to sum, and the initial state of qubit C may comprise a ground or zero state (e.g., the |0> state), to which the sum of A and B may be added.

In some exemplary embodiments, at an initial phase of a quantum circuit execution, such as at a prefix portion of the circuit, the one or more initial quantum states may be prepared, or loaded, on the qubits. In some exemplary embodiments, qubit states may be set at a start of an execution of a program, such as prior to the qubits being manipulated by the quantum circuit's functionality, business logic, or the like. For example, in case the quantum circuit's functionality is summing up the states of qubits A and B into qubit C, the initial states of the qubits may be prepared by a sub-circuit that is implemented at one or more first cycles of the quantum circuit, and the quantum circuit may include one or more qubit manipulations or gates that set the initial states on qubits A, B and C. According to this example, the subsequent cycles of the quantum circuit may be used to sum the states of A and B into C.

In some cases, loading the initial quantum states by the quantum circuit may have one or more drawbacks, e.g., may be time consuming, resource consuming, or the like. For example, setting a complex state to a qubit may require to utilize multiple qubits, gates and/or cycles, may be time consuming, may increase an error rate of the circuit, or the like. As another example, setting some states to a qubit may require to utilize one or more types of 2-qubit quantum gates that may be expensive, limited, or the like. It may be desired to prepare states of qubits for a quantum circuit in a resource conserving manner, such as by reducing a quantity of gates, cycles, qubits, or the like, that are used for loading the qubits' states.

Yet another technical problem dealt with by the disclosed subject matter is enabling a user to control an accuracy of a state setting operation, e.g., in an adjustable and personalized manner.

One technical solution provided by the disclosed subject matter comprises transforming one or more initial quantum states that are intended to be set on respective qubits, to obtain respective modified states. In some exemplary embodiments, the term ‘qubit’, as used herein, may refer to one individual qubit, or to a qubit register (e.g., a group of qubits). In some exemplary embodiments, the modified states may represent the initial quantum states in a sparce and resource conserving manner. In some exemplary embodiments, a modified quantum circuit may be generated, in which the modified states are prepared on the respective qubits instead of the initial states, thereby saving resources compared to setting the non-modified initial states on the qubits. In some exemplary embodiments, the initial quantum states may be at least partially reconstructed from the modified states of the qubits, such as by applying an inverse transformation of the modified states.

In some exemplary embodiments, in order to transform an initial quantum state, a transformation that can transform the initial state to a modified representation may be selected from a set of potential transformations. In some exemplary embodiments, the transformation may comprise a matrix (e.g., a transformation matrix) that can be used to manipulate a value that represents a state of a qubit. In some exemplary embodiments, a transformation may be selected to be used for transforming an initial state, in case that the transformation is estimated to be useful in the realm of the quantum program, in case the transformation can be efficiently implemented in a classical computer, in case the transformation has an efficient quantum implementation, or the like. In some exemplary embodiments, the transformation may be selected in case its matrix is implementable by both a classical computer and a quantum computer.

In some exemplary embodiments, a transformation may be selected to represent an initial state for a qubit in case that the base of the transformation is a more efficient than the base of the initial state. In some cases, a first base may be considered more efficient than a second base in case it uses less coefficients. For example, in case the initial state is represented by 35 coefficients that are defined over a first base, the initial state may be selected to be transformed to a second base that requires only 3 coefficients to represent the same value. Examples of transformations that may be useful in one or more scenarios include the Fourier transformation, the Hadamard transformation, the Discrete Cosine Transform (DCT) technique, the Wavelet transformation, or the like. It is noted that different transformations may be selected for different initial states. For example, in case the Hadamard transformation is efficient for transforming a first initial state of a first qubit, it may not be efficient for transforming a second initial state of a second qubit. In such cases, the second initial state may be transformed using a different transformation, such as the Wavelet transformation. It is noted that in some cases, the second initial state may not be transformed at all, and the second qubit may be initialized with the second initial state, as originally designed.

In some exemplary embodiments, a preprocessing stage may be implemented on a classical computer. In some exemplary embodiments, the preprocessing stage may comprise selecting a transformation for an initial state, and transforming the initial state to a modified state. In some cases, the preprocessing stage may potentially compress the modified state. In some cases, the compression may be a lossy compression, such as by removing one or more coefficients that represent the modified state. In some exemplary embodiments, the preprocessing stage may be implemented by a classical computer, thereby shifting computational resources from the quantum computer to the classical computer, in order to generate a simplified and scarce quantum state that represents the initial quantum state. In some exemplary embodiments, transforming and/or compressing the initial state may correspond to a “zipping” stage of a file compression method, and may be performed at a classical computer, a non-quantum computer, or the like, while inversing the transformation may correspond to the “unzipping” stage of a file compression method during which the original content is retrieved. In some exemplary embodiments, transforming and/or compressing the initial state may reduce a complexity of a representation of the initial state, and simplify the usage thereof. For example, preparing a state with a reduced complexity may utilize less resources than preparing the original state.

In some exemplary embodiments, in case that the modified state is compressed, the modified state may or may not be lossy. In some exemplary embodiments, in case of a lossy compression of the initial state, some original state information of the initial state may be lost without being restorable, possibly affecting a state accuracy of an output of the quantum circuit, an error rate of the output, a quality of the output, or the like. For example, in case of a lossy compression, reproducing an exact version of the initial state with an accuracy of 100% may be impossible.

In some exemplary embodiments, a tradeoff may exist between an accuracy of an output and an efficiency of the state preparation. In some exemplary embodiments, a modified state may be compressed in case that the loss of the compression complies with a user requirement. For example, a user may indicate (e.g., via a user interface) that the accuracy of the modified state (e.g., the percentage of quantum information that is not lost by the transformation), must be higher than a threshold. As another example, the user may provide an objective function that assigns a weight for utilizing each type of resource, and a weight for a reduced accuracy. In such cases, the objective function may be utilized for selecting a compression method for an initial state.

In some exemplary embodiments, after the pre-processing stage, a modified quantum circuit may be generated during a ‘processing’ stage. In some exemplary embodiments, the modified quantum circuit may be generated by modifying the quantum circuit to replace one or more sub-circuits of the quantum circuit with new sub-circuits. In some exemplary embodiments, instead of modifying an existing quantum circuit, the modified quantum circuit may be obtained by generating a new quantum circuit that includes the new sub-circuits instead of the previous sub-circuit. In some exemplary embodiments, the modified quantum circuit may comprise new sub-circuits that are configured to prepare one or more modified states on respective qubits or qubit registers. In some exemplary embodiments, setting a modified state to a qubit may utilize less resources compared to setting the initial state to the qubit, e.g., due to its simplified representation.

In some exemplary embodiments, modified quantum circuit may set a modified state on a qubit using one or more quantum state setters (‘setters’), at an individual qubit level or at a quantum register level (e.g., a set of qubits). In other cases, modified quantum circuit may utilize any other technique to prepare a modified state on a qubit. In some exemplary embodiments, setters may be enabled to set, or apply, one or more types of states, or quantum information, to respective qubits. In some exemplary embodiments, each setter may be attached, wired, or otherwise associated with an individual qubit, a group of qubits such as a quantum register, or the like. In case of a qubit register, the respective setter may treat the group of qubits collectively and apply a single state over the entire group of qubits. For example, one or more setters may be configured to set qubits in one or more random or determined computational basis states, maximally-mixed states, maximally-entangled states, highly-entangled states, or the like. In some exemplary embodiments, the setters may be included within the modified quantum circuit, or may be deployed externally thereof.

In some exemplary embodiments, each modified state may be set on the respective qubit iteratively, in parallel, or the like, until all the determined modified states are set on the respective qubits. It is noted, however, that not all of the qubits in the quantum circuit may be set with modified states. For example, in case an initial state is determined to be sufficiently efficient (e.g., in case preparing the initial state on a qubit is estimated to utilize less resources than a threshold), and/or in case a transformation that is sufficiently efficient is not found for the initial state, the modified quantum circuit may set the initial state on the qubit. It is further noted that an efficiency of a preparation of a state may be estimated based on an objective function, or based on any scoring system that enables to score and compare a usage of resources using any determined weights.

In some exemplary embodiments, the modified quantum circuit may be further generated to comprise, for each modified state, an inverse transformation. In some exemplary embodiments, one or more inverse transformations may be applied on the modified states on the respective qubits, such as during subsequent cycles of the modified quantum circuit. In some exemplary embodiments, for any quantum operation, such as a function, a state, a gate, or the like, an inverse operation may exist. For example, inverse operations are described in the Unitary Inversion of Gates section in ‘Quantum logic gate’ entry in Wikipedia, available at ‘en.wikipedia.org/wiki/Quantum_logic_gate’, which is hereby incorporated by reference in its entirety for all purposes without giving rise to disavowment. In some exemplary embodiments, an inverse transformation that inverses a transformation of an initial state of a qubit, may be applied to the qubit in its modified state, in order to reconstruct the initial state. In some exemplary embodiments, the inverse transformation may be used in order to reproduce the initial state of the qubit, an approximation of the initial state, or the like. In some exemplary embodiments, the inverse transformation may be implemented in case that the initial state is used in subsequent computations of the quantum program.

In some exemplary embodiments, the inverse transformations may be implemented by concatenating the inverse transformations to a sub-circuit of the modified quantum circuit that prepares the quantum states of the qubits. In other cases, the inverse transformations may be implemented by concatenating the inverse transformations in any other portion of the modified quantum circuit. In some cases, the inverse transformation may be implemented within the quantum circuit, externally thereof, or the like.

In some exemplary embodiments, the resulting modified quantum circuit may comprise an original sub-circuit that implements the functionality of the quantum circuit, which may not be modified, together with new sub-circuits that implement one or more setters that prepare modified states, that implement one or more inverse transformations, or the like. In some exemplary embodiments, the modified quantum circuit may be executed, simulated, or the like, thereby saving time, qubits, gate resources, or the like, compared to executing the original quantum circuit.

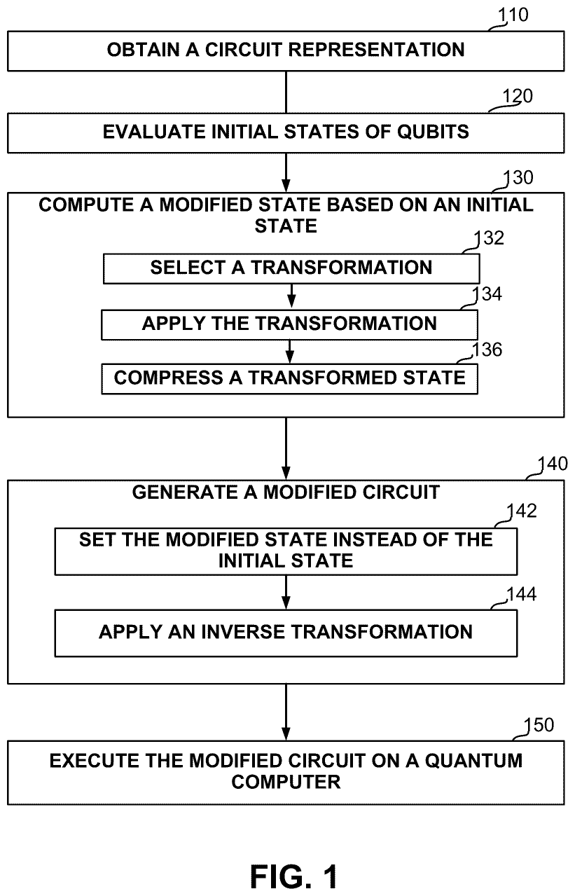

In some exemplary embodiments, the modified quantum circuit may be generated, created, or the like, using one or more algorithms, techniques, or the like, e.g., as follows:
1. Utilize a classical computer to transform a quantum state Q using a transformation matrix T, to create a transformed quantum state Q′.
2. Perform a state preparation of the transformed quantum state Q′ by creating a quantum program that produces the transformed quantum state Q′.
3. Implement an inverse transformation T⁻¹ in the quantum program, which is the inverse of the transformation matrix T.
4. Concatenate the quantum state Q′ with the inverse transformation T⁻¹, to reconstruct the desired quantum state Q.
   For example, Step 1 of this exemplary algorithm may correspond to Step 134 of FIG. 1, Step 2 of the algorithm may correspond to Step 142 of FIG. 1, and Steps 3 and 4 of the algorithm may correspond to Step 144 of FIG. 1.

One technical effect obtained by the disclosed subject matter is enabling to reduce resources that are used for executing a quantum circuit. Since the preprocessing stage is performed by a classical computer, and the modified state is more efficiently loaded than the initial state, quantum resources for setting the initial states are saved. In some exemplary embodiments, executing the modified quantum circuit may be resource conserving compared to executing the original quantum circuit, at least since the resources that are required for preparing the initial states may be reduced. In some exemplary embodiments, the modified quantum program enables to restore at least an approximation of the initial states in a resource conserving manner (e.g., due to the simplified transformation and inverse transformation), while ensuring that the functionality of the circuit is maintained. It is noted that in some cases, the functionality may be considered as maintained if a reasonable approximation is utilized, even if the final output state is not identical to the one that the original circuit would have produced. In some cases, if the output is within a threshold error to the original output value, the functionality may be considered as maintained.

Another technical effect obtained by the disclosed subject matter is providing a user-adjustable resource utilization. In some exemplary embodiments, a user may be enabled to select a level of accuracy that is expected from a compression, thus ensuring that lossy compressions that are selected for representing an initial state comply with an accuracy requirement of the user. In some exemplary embodiments, the degree of compression may be adjustable, thus allowing a selectable tradeoff between resource utilization and state accuracy.

Yet another technical effect obtained by the disclosed subject matter is shifting computational resources from one or more quantum computers to one or more classical computers, which distributes a preparation of quantum states between multiple computers. In some exemplary embodiments, the disclosed subject matter enables a classical computer to share the burden of preparing quantum states, by utilizing classical resources for transforming initial states to modified states. In some exemplary embodiments, the distribution of the processing resources over classical and quantum computers enables to conserve quantum resources such as an execution time, a number of gates that are used, a number of qubits that are used, a combination thereof, or the like, in comparison with using a quantum computer to set the initial state on the qubits. In some exemplary embodiments, the preprocessing stage, in which the initial state is transformed (e.g., using resources of a classical computer), and/or executing the modified circuit, may utilize less quantum resources compared to executing the original circuit. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

Referring now to FIG. 1, showing an exemplary flowchart diagram of a method, in accordance with some exemplary embodiments of the disclosed subject matter.

On Step 110, a representation of a quantum circuit may be obtained. In some exemplary embodiments, the representation may comprise a gate-level representation of the circuit, a functional-level representation of the circuit, or the like. The quantum circuit may also be referred to as the ‘original quantum circuit’.

On Step 120, one or more initial quantum states that are associated with qubits of the quantum circuit may be determined, evaluated, extracted, or the like. In some exemplary embodiments, the initial quantum states may comprise quantum states that the quantum circuit prepares on the qubits of the quantum circuit. In some exemplary embodiments, a quantum state may refer to quantum information (e.g., a linear combination of two states) that is carried by a qubit, a qubit register, or the like. Quantum states may include various types of states such as maximally-mixed states, maximally-entangled states, highly-entangled states, e.g., as disclosed in U.S. patent application Ser. No. 17,752,282, tiled “Auxiliary Qubit Verification In Quantum Circuits”, filed May 24, 2022, which is hereby incorporated by reference in its entirety without giving rise to disavowment.

In some exemplary embodiments, an initial quantum state may be associated with a qubit of the quantum circuit or a qubit register that includes one or more qubits (both referred to herein as a ‘qubit’). In some exemplary embodiments, an initial quantum state may refer to a quantum state that is configured to be prepared for a qubit by the quantum circuit, e.g., when executing or simulating the quantum circuit. For example, in case the quantum circuit implements a function that receives arguments, the values of the arguments of the function may correspond to initial quantum states of the circuit. As another example, in case the quantum circuit implements a function that utilizes an auxiliary qubit for temporary memory, an initial state of the auxiliary qubit may comprise a ground or zero state.

In some exemplary embodiments, the quantum circuit may comprise a sub-circuit that is configured to set the initial quantum state on the one or more qubits. In some exemplary embodiments, the initial quantum state may be configured to be prepared for the qubit at beginning of the quantum circuit, such as at a prefix subcircuit of the quantum circuit that is executed before the remaining portions of the circuit, at one or more initial cycles of the quantum circuit, or the like.

In some exemplary embodiments, an initial quantum state of each qubit, or qubit register, of a quantum circuit may be determined. In some exemplary embodiments, initial quantum states may be determined for all qubits of the circuit, or for a portion thereof. In some exemplary embodiments, the initial quantum states may be extracted, estimated, measured, or the like, based on the representation of the circuit. For example, an initial quantum state may be determined by executing the quantum circuit, simulating the quantum circuit, or the like. According to these examples, the initial states of the qubits may be measured, determined, or the like, using quantum state tomography, or using any other technique for measuring quantum states that can be applied to the simulation or execution environment, and estimated to constitute the initial quantum states of the qubits. In some exemplary embodiments, the state of the qubits may be measured over one or more initial cycles of the circuit, over a defined cycle of the circuit (e.g., obtained from a user), over a defined sub-circuit, or the like. In some exemplary embodiments, prior to loading the initial quantum states on the qubits, the qubits may typically be in a zero state, a ground state, an unknown state, or the like, and thus it may be desirable to identify subsequent states of the qubits as constituting the initial states.

In some cases, at least a portion of the initial quantum states may be extracted, estimated, measured, or the like, based on a static analysis of the quantum circuit, such as without executing or simulating the quantum circuit. For example, a high-level quantum program that is implemented by the quantum circuit may be analyzed to identify values of arguments. In other cases, the initial quantum states may be determined based on any other technique or heuristics, such as based on a user input, based on compiler indications, or the like. For example, the user may provide to a quantum compiler, values for arguments of a quantum function, and the values may be estimated to constitute at least some initial states of the qubits, e.g., without executing or analyzing the circuit.

On Step 130, at least one modified state may be computed, determined, calculated, or the like, for a respective initial state that was determined in Step 120. In some exemplary embodiments, a modified state may be computed at a classical computer, a non-quantum computer, or the like. In some exemplary embodiments, a modified state may be determined based on an initial state that is associated to the quantum circuit, and a selected transformation. For example, each modified state that is associated with an initial state may be computed according to Steps 132-136. In some exemplary embodiments, a modified state may be determined for each initial state that is identified in Step 120, or to a portion thereof, and may correspond to the same qubits with which the initial state is associated. For example, in case that an initial state is configured to be set, in the quantum circuit, on a qubit register, the respective modified state may be associated to the same qubit register.

On Step 132, a transformation for transforming a value of an initial state may be selected. In some exemplary embodiments, the transformation may be selected at a classical computer, a non-quantum computer, or the like. In some exemplary embodiments, the transformation may be used to transform the initial quantum state to a modified quantum state that represents the initial state in a different state base. For example, a transformation may utilize techniques such as one or more transformation matrixes, a linear dimension reduction (e.g., a Principal Component Analysis (PCA)), signal processing methods, state transfer methods such as the Discrete Fourier Transform (DFT) technique, the Discrete Cosine Transform (DCT) technique, or the like, in order to transfer an initial state in a first base to a modified representation of the initial state in a second base.

In some exemplary embodiments, a transformation for transforming an initial state may be selected from a set of potential transformations. For example, the set of potential transformations may comprise transformations that can be applied in both quantum and classical computers. As another example, the set of potential transformations may comprise transformations that, when applying them in quantum or classical computers, utilize less resources (time resources, computation resources, or the like) than a resource threshold. The resource threshold may relate to one or more types of resources, to a weighted or non-weighted combination thereof, or the like.

In some exemplary embodiments, a transformation may be selected to be used to transform an initial quantum state based on one or more conditions, rules, or the like, which may or may not be relative to other transformations. In some cases, different transformations may be selected to transform different initial states. In some cases, a single transformation may be selected to transform different initial states.

In some exemplary embodiments, a transformation for an initial state may be selected from the set of potential transformations in case it enables to produce a modified quantum state that comprises a scarce, or diluted, representation of the initial quantum state. For example, the initial quantum state may be represented by a first set of coefficients over a first state base, and the modified quantum state may be represented by a second set of coefficients over a second state base. According to this example, the modified quantum state may be considered a scarce representation of the initial quantum state in case that the first set of coefficients comprises a greater number of coefficients than the second set of coefficients. In some exemplary embodiments, a transformation may be selected only in case it converts an initial quantum state to a modified state that represents the initial state in a scarce form. For example, the DCT state transfer technique may convert an initial state from a time domain into a frequency domain, e.g., by expressing a finite sequence of data points in terms of a sum of cosine functions oscillating at different frequencies. This technique may enable, in some scenarios, to reduce a large set of coefficients into a smaller one.

In some exemplary embodiments, a transformation may be selected for an initial quantum state, in case that the transformation can be implemented by a classical computer and by a quantum computer. In some exemplary embodiments, a transformation may be considered implementable by a computer in case that implementing the transformation by the computer is feasible, in case that implementing the transformation by the computer utilizes less resources than a resource threshold, or the like.

It is noted that estimating a number of resources of an operation may relate to calculating a number of time units that are needed for implementing the operation, a number and type of computational components that are needed for implementing the operation, or the like. Based on these parameters, a calibration may be performed, producing an overall ‘resource score’ for the operation. For example, the resource score may be determined based on a weighted objective function (e.g., provided by a user), heuristics, a defined rule for combining the different parameters to a single score, or the like. For example, for an operation that is implemented in a quantum computer, the resource score may relate to one or more types of gates that are used to implement the operation (e.g., two-qubit gates), a quantity thereof, a quantity of cycles, a quantity of qubits, or the like. As another example, for an operation that is implemented in a classical computer, the resource score may relate to memory storage, execution time, or the like. Higher resource scores may indicate that more resources are used, and vice versa. In some exemplary embodiments, estimations of resource consumption of operations may be performed dynamically, e.g., by executing or simulating a respective quantum circuit, or statically. e.g., without executing the quantum circuit, such as by analyzing the quantum circuit, analyzing historic executions thereof, or the like.

In some exemplary embodiments, a resource score of an operation may depend on an accuracy level that the operation received. For example, in order to compare a resource score of two operations, the resource scores may be computed for the respective operations, when implemented with a same accuracy level. In some exemplary embodiments, in order to determine whether a difference in resources that are used by two operations is significant, the difference between the resource scores may be compared to a threshold.

In some exemplary embodiments, a transformation for an initial state may be selected in case it reduces an estimated number of resources that is required for preparing the initial state on a qubit, e.g., indicated by a reduced resource score. For example, a first resource score indicating an estimated amount of quantum resources for setting the modified quantum state on the one or more qubits may be computed, and a second resource score indicating an estimated amount of quantum resources for setting the initial quantum state on the one or more qubits may be computed. According to this example, the resource scores of both operations may be compared, and the transformation may be selected in case that the first resource score is lesser than the second resource score. In some cases, the transformation may be selected in case that the difference in the resource scores are significant, or irrespective thereof.

In some exemplary embodiments, a transformation may be selected based on an estimated number of classical resources that are required for transforming the initial state to a modified state, based on an estimated number of quantum resources that are required for setting the modified state on the respective qubits, based on an estimated number of quantum resources that are required for setting the initial quantum state on the one or more qubits, based on an estimated number of quantum resources that are required for implementing the transformation (and an inverse thereof) in the quantum circuit, or the like. For example, the number of quantum resources for setting the initial quantum state may be compared to a sum of the remaining resources, and the transformation may be selected in case that setting the initial quantum state is estimated to use more resources compared to the sum of at least a portion of the remaining operations. In some exemplary embodiments, in case that more than one transformation is found for an initial state, one of them may be selected based having a lesser resource score, based on heuristics, or the like.

Examples of transformations that may be included in the set of potential transformations may include the Fourier transformation, the Hadamard transformation, the DCT technique, the Wavelet transformation, or the like. These transformations may have a simple quantum implementation (having a resource score below a threshold), as well as a classical implementation, thus complying with at least some of the selection criteria. For example, the Fourier transformation, and the corresponding inverse Fourier transformation, may have a simple and resource conserving quantum implementation, as well as a classical implementation. As another example, the Hadamard transformation, as its inverse transformation, may have a simple and resource conserving quantum implementation known as the Hadamard gate. As another example, the DCT may be configured to transform a state to a cosine base, and vice versa, and may be implementable by a quantum computer and by a classical computer. As another example, the Wavelet transformation may be configured to transform various signals to a sparce representation, and may be implementable by quantum and classical computer.

In some exemplary embodiments, a transformation may not be selected to be used in case it does not decrease the number of coefficients in the second base, does not reduce the number of resources for preparing the initial state on a qubit, or the like. In some cases, such as in case no transformation is selected for an initial quantum state, the initial quantum state may be determined not to be modified by any transformation. For example, in case the set of potential transformations does not comprise a transformation that decreases the number of coefficients of an initial quantum state, no transformation may be selected and applied to that initial state. In such cases, Step 130-140 may not be applied to the initial quantum state and the corresponding qubits.

On Step 134, the selected transformation may be utilized to transform the initial quantum state to a transformed quantum state, e.g., on the classical computer. In some exemplary embodiments, the transformed quantum state may be computed based on an application of the transformation on the initial quantum state. In some exemplary embodiments, the transformed state may scarcer, or decreased in size, compared to the initial state. For example, the transformed state may comprise a representation of the initial state that uses less coefficients.

On Step 136, the transformed state may be compressed in order to further dilute the representation of the initial state, thereby generating a modified quantum state. In some exemplary embodiments, after applying the selected transformation on the initial quantum state, the transformed quantum state may be compressed to obtain the modified quantum state. In some exemplary embodiments, this step may be an optional step that may be omitted in many cases, such as in case that a user requires the initial state to be fully reconstructed within the quantum circuit. In such cases, the modified quantum state may refer to the transferred quantum state.

In some exemplary embodiments, the compression stage may be configured to further reduce a size of the representation of the initial state. In some exemplary embodiments, the compression stage may utilize one or more compression techniques that may or may not be lossy. In some exemplary embodiments, a lossy compression of an initial state may comprise an approximation of the initial state that reduces the state fidelity, in a manner that prevents generating an exact reproduction of the initial state data. For example, the output of the compression may be trimmed to remove one or more coefficients therefrom. e.g., as part of a lossy compression.

In some exemplary embodiments, in case of a lossy compression, the transformed quantum state may be represented by a set of coefficients in a state base, and compressing the transformed quantum state may comprise removing one or more coefficients from the set of coefficients. In some exemplary embodiments, the one or more coefficients may be selected to be removed by the compression, based on a determination that the one or more coefficients are insignificant. In some exemplary embodiments, an output of the compression may comprise a scarce state representation that utilizes less coefficients than the transformed quantum state, in the same state base as the transformed quantum state or in a different state base. For example, coefficients of a base of a transformed state that have an impact that is below a relative or absolute threshold, or a value that is below a threshold, may be determined to be insignificant, to constitute noise, or the like, and may be removed from the representation. In other cases, a compression of the initial state may be lossless, or not lossy, such as by applying a reproduceable compression that retains all the coefficients.

In some exemplary embodiments, in case of a lossy compression, an inversion of the transformation may not be able to provide a full reconstruction of the initial quantum state. For example, implementing the compression stage may prevent, or limit an ability to fully reconstruction the initial quantum state by the inverse transformation of Step 140, at least since the removed coefficients may not be reconstructable.

In some exemplary embodiments, a compression technique may be selected to be used in case it complies with an accuracy threshold, e.g., a default threshold, a user selected threshold, or the like. For example, in case the user requires the circuit to retain the exact reproduction of the initial state data, a lossy compression may not be used. In some exemplary embodiments, an accuracy of a compression may relate to a percentage of quantum information that is not lost by applying the compression to the transformed state. For example, in case 95% of an initial state can be restored from a transformed and compressed representation thereof, the loss may be defined as 5%, and the accuracy may be defined as 95%. In some exemplary embodiments, a selection and usage of a compression may be limited by accuracy constraints, such as constraints defining that a loss cannot pass a defined percentage, that an accuracy must be higher than a defined percentage, or the like. For example, a user, or any other entity, may define that a loss cannot be greater than 1%, thus limiting a selection of potential compressions to compressions that enables to restore at least 99% of the initial state.

On Step 140, a modified quantum circuit may be generated, e.g., according to Steps 142-144. In some exemplary embodiments, the modified quantum circuit may be generated at a classical computer, a non-quantum computer, or the like. In some exemplary embodiments, the modified quantum circuit may be generated based on the original quantum circuit and based on one or more modified quantum states of respective qubits. In some exemplary embodiments, the modified quantum circuit may be generated by modifying the quantum circuit, by generating a new quantum circuit that has at least some overlapping subcircuits with the quantum circuit, or the like. In some exemplary embodiments, the modified quantum circuit may be configured to be executed by a quantum computer.

On Step 142, the modified quantum circuit may be generated to prepare, or set, one or more modified quantum states on respective qubits, instead of setting the initial quantum state on the qubits. In some exemplary embodiments, a modified quantum state (which may or may not be compressed) may be prepared on a respective qubit or qubit register.

In some exemplary embodiments, the modified quantum circuit may be generated to exclude at least a portion of an original sub-circuit of the original quantum circuit that is configured to set the initial quantum states on the qubits, thereby not setting all of the initial quantum states on the qubits of the circuit. In some exemplary embodiments, the modified quantum circuit may be generated to replace the original sub-circuit with a modified sub-circuit that is configured to set the modified quantum states on the respective qubits. For example, the modified quantum circuit may comprise a quantum circuit that is newly generated to include a sub-circuit that prepares the modified quantum state on the respective qubit. As another example, the modified quantum circuit may comprise a modified version of the original quantum circuit that is modified, adjusted, or the like, to include a modified sub-circuit that prepares the modified quantum state on the qubit, instead of an original sub-circuit of the original quantum circuit that prepares the initial quantum state on the qubit.

In some exemplary embodiments, the modified quantum state may be set on the qubits during one or more initial cycles of the modified quantum circuit. For example, the modified quantum state may be prepared on the qubits at a sub-circuit that is concatenated to a beginning of the quantum circuit, at a prefix circuit, or the like. In other cases, the modified quantum state may be set on the qubits during any other set of cycles.

In some exemplary embodiments, generating the modified quantum circuit may comprise setting, or loading, the modified quantum state on the one or more qubits using one or more quantum state setters (‘setters’). In some exemplary embodiments, the setters may be enabled to set, or apply, one or more types of states, or quantum information to one or more respective qubits. In some cases, setters may utilize one or more generators in order to apply states to input qubits. For example, a setter may set a determined highly-entangled state to a qubit using a random highly-entangled state generator, similarly to the method disclosed in J. Emerson, Random Quantum Circuits and Pseudo-Random Operators: Theory and Applications. Science 302, 2098 (2003), which is hereby incorporated by reference in its entirety for all purposes without giving rise to disavowment. In other cases, any other generator or mechanism may be utilized in order to apply quantum states to qubits of a quantum circuit, to create quantum states, or the like.

On Step 144, the modified quantum circuit may be generated to comprise one or more inverse transformations that are applied to respective modified states. In some exemplary embodiments, generating the modified quantum circuit may comprise injecting the inverse transformation into the modified circuit, including the inverse transformation in the modified circuit, or the like.

In some exemplary embodiments, the inverse transformation may be configured to inverse the transformation that was selected on Step 132, and potentially the compression of Step 134 (e.g., in case the compression is not lossy). In some exemplary embodiments, the inverse transformation may be concatenated to the modified quantum state of the qubit. In some exemplary embodiments, the application of the inverse transformation on the modified quantum state of the qubit may be configured to restore the initial quantum state of the qubit or an approximation thereof. In some exemplary embodiments, inversing the modified state may enable to create or reconstruct the initial state, for further processing by the quantum circuit.

In some exemplary embodiments, an inverse transformation may be implemented at one or more subsequent cycles of the modified quantum circuit, that are subsequent to the initial cycles of the modified quantum circuit during which the modified state was set on the qubits. In some exemplary embodiments, the one or more subsequent cycles of the quantum circuit may be positioned after the one or more initial cycles, e.g., in a time-wise axis.

In some cases, the subsequent cycles of the quantum circuit may or may not be adjacent to the one or more initial cycles. For example, in case that the initial state is not manipulated by quantum computations of the quantum circuit during one or more cycles that are adjacent to the initial cycles, the inverse transformation may or may not be delayed in one or more cycles. In such cases, the inverse transformation may be implemented at any cycle before the quantum computations, thus ensuring that the quantum computations can utilize the restored initial states.

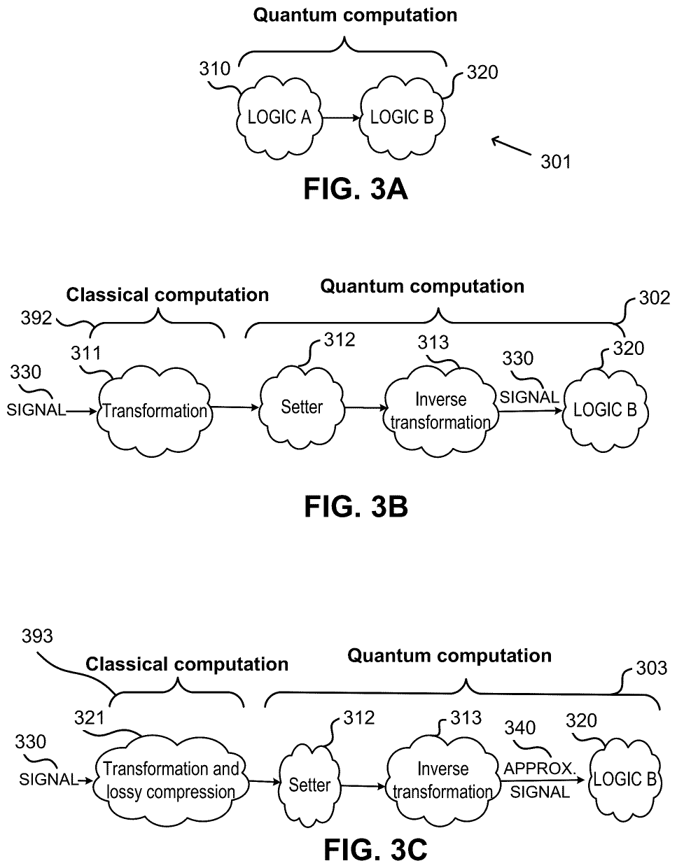

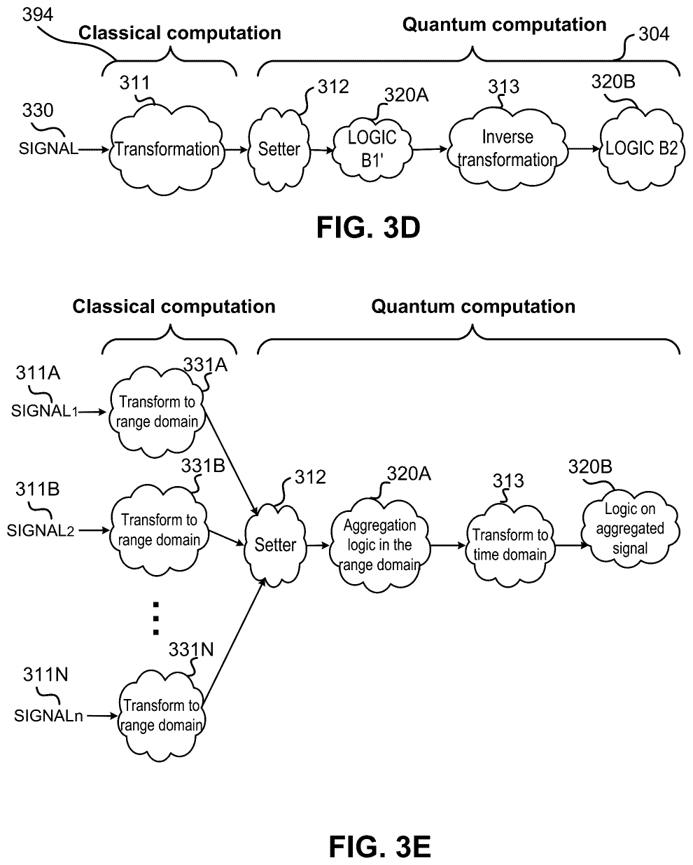

In some cases, the inverse transformation may be implemented at one or more cycles after at least a portion of the quantum computations, such as according to the scenario of FIGS. 3D and 3E. This may be performed in case that the modified state can be manipulated by the quantum computations in a more efficient manner than the initial state. For example, in case that the modified state is represented in a frequency domain, and the quantum circuit is configured to manipulate a frequency, which is performed more efficiently in a frequency domain, the modified state may be retained during the frequency manipulations, and the inverse transformation may be implemented after the frequency manipulations.

For example, in case that the initial state represents audio signals in a time domain, the modified state represents the audio signals in a frequency domain (e.g., when using the Fourier transformation), and the quantum computations are configured to sum or aggregate the audio signals, it may be beneficial to implement the quantum computations on the modified state. According to this example, the transformation may advantageously not be reversed prior to the summing of the audio signals. In some cases, additional circuit modifications may be performed in order to enable the circuit to process the modified states. For example, the circuit may be adjusted to match signals in the frequency domain.

In some cases, such as in case that the initial state is not configured to be used by any subsequent manipulations of the circuit, the inverse transformation may not necessarily be implemented by any portion of the modified quantum circuit. For example, in such cases, a classical computer may apply the inverse transformation on an outputted quantum state of the qubit, after it is outputted from the modified quantum circuit.

On Step 150, the modified circuit may be executed on a quantum computer, a quantum simulator, or the like. In some exemplary embodiments, the modified circuit may utilize less resources than executing the original quantum circuit. For example, executing the quantum circuit may utilize at least one unit of a quantum resource that is not utilized when executing of the modified quantum circuit. As another example, the resource score of the modified circuit may be lesser than the resource score of the original circuit (e.g., indicating that the modified quantum circuit utilizes less resources).

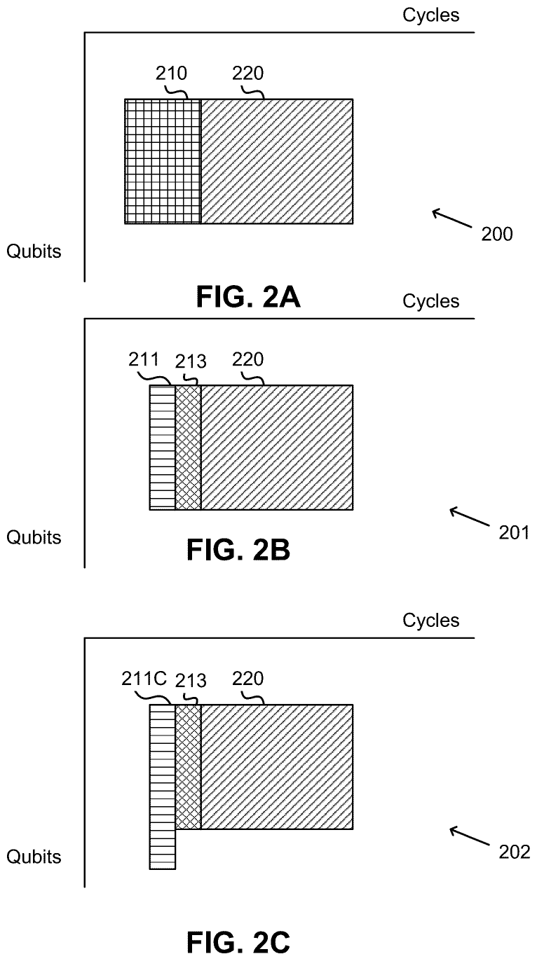

Referring now to FIGS. 2A-2C showing exemplary quantum circuits, in accordance with some exemplary embodiments of the disclosed subject matter.

As depicted in FIG. 2A, Circuit 200 comprises a quantum circuit that manipulates a set of qubits over a set of cycles. Circuit 200 may be configured to prepare one or more initial states on the set of qubits. Circuit 200 may comprise a first Setting Portion 210, during which the qubits may be set with initial states, and a second Functional Portion 220, during which the initial states of the qubits may be manipulated according to a programmed functionality of Circuit 200. For example, Setting Portion 210 may set the initial states of the qubits according to a user instruction, and Functional Portion 220 may include gates that manipulate the qubits and provide an output state via an output qubit. Circuit 200 may have one or more drawbacks. For example, Setting Portion 210 may use a sub-optimal quantity of resources.

As depicted in FIG. 2B, Circuit 201 may comprise a quantum circuit that manipulates a set of qubits over a set of cycles. In some exemplary embodiments, Circuit 201 may at least partially correspond to Circuit 200, as they may both comprise the same Functional Portion 220. However, instead of Setting Portion 210, Circuit 201 may comprise Setting Portion 211 and Inverse Portion 213.

In some exemplary embodiments, Circuit 201 may be generated at a classical computer, by applying one or more transformations on the initial states that are set by Setting Portion 210, to obtain respective modified states that represent the initial states. In some exemplary embodiments, Circuit 201 may be generated to comprise a Setting Portion 211 for preparing the modified states on at least a portion of the qubits. In some exemplary embodiments, Circuit 201 may be further generated to comprise an Inverse Portion 213 for inversing the modified states of the qubits, thereby reconstructing or approximating the initial states. Portions 211 and 213, together, may utilize less resources than Setting Portion 210 of FIG. 2A.

As an example, an initial state for a qubit may be represented over a sine signal state base. Accordingly, Setting Portion 210 of FIG. 2A may prepare initial states that are represented over the sine signal base, on the respective qubits. In some exemplary embodiments, in contrast to FIG. 2A, Setting Portion 211 of FIG. 2B may obtain a modified state, that represents the initial state over a different state base. For example, the sine base may be transformed to a Fourier series, over which a diluted representation of the initial state (e.g., including a reduced number of coefficients) may be defined. In some exemplary embodiments, the diluted modified representation may or may not be further compressed, such as by removing less significant coefficients that are defined in the new base. In some exemplary embodiments, Setting Portion 211 may prepare the modified representation of the initial state on the qubit, and Inverse Portion 213 may prepare an inverse transformation, inversing the Fourier series, on the qubit. In some exemplary embodiments, this resulting state of the qubit may comprise a full or partial reconstruction of the original initial state that is defined over the sine base, which may be needed for further computations of Circuit 201.

In some exemplary embodiments, executing Circuit 201 may be determined to be more efficient than executing Circuit 200, e.g., in case that executing Portions 211 and 213 utilizes less resources than executing Setting Portion 210 of FIG. 2A.

In some exemplary embodiments, Setting Portions 211 and Inverse Portion 213 of FIG. 2B are exemplified in FIG. 2A as utilizing a same number of qubits as Setting Portion 210 of FIG. 2A, with a lower number of cycles. However, the disclosed subject matter is not limited to such a configuration, and any other distribution or tradeoff of resources may be used by Setting Portions 211 and Inverse Portion 213. For example, Portions 211 and 213 may not be shaped as rectangles, and may instead include any other shape, indicating any other allocation of qubits and cycles. For example, Portions 211 and 213 may include various gaps in the cycle and/or qubit axis, a portion of either circuit may utilize non-adjacent qubits, a greater number of cycles or qubits than Setting Portion 210, or the like.

In some exemplary embodiments, Setting Portion 211 may comprise any implementation, as long as the overall resource score of Setting Portion 211 and Inverse Portion 213, together, is lesser than the resource score of Setting Portion 210. For example, as depicted in FIG. 2C. Setting Portion 211C comprises an implementation of Setting Portion 211 that uses a greater number of qubits than the number of qubits that are used by Setting Portion 210. In other cases, the number of cycles used by Setting Portion 211C may be greater than the number of qubits that are used by Setting Portion 210. In some exemplary embodiments, as long as Portions 211C and 213, together, provide a lesser resource score than Setting Portion 210 of FIG. 2A, Portions 211C and 213 may utilize any number of cycles and qubits.

Referring now to FIGS. 3A-3E showing exemplary quantum and classical computations, in accordance with some exemplary embodiments of the disclosed subject matter.

FIG. 3A depicts an exemplary Circuit 301 implementing quantum computations. Circuit 301 may comprise two concatenated portions: Sub-Circuit 310 and Sub-Circuit 320. Sub-Circuit 310 may comprise logic that is configured to prepare initial quantum states on the qubits of Circuit 301, while Sub-Circuit 320 may comprise logic that is configured to manipulate the initialized qubits according to a desired functionality of Circuit 301. In some cases, Sub-Circuit 310 and Sub-Circuit 320 may correspond to Setting Portion 210 and Functional Portion 220 of FIG. 2A.

FIG. 3B depicts an exemplary Circuit 302 and a Classical Computation 392. Classical Computation 392 may apply a Transformation 311 on a Signal 330 that represents an initial state of a qubit in Circuit 302, to thereby obtain a modified signal that represents a scarce representation of the initial state of the qubit.

In some exemplary embodiments, based on the modified signal, Circuit 302 may be generated to comprise a first sub-circuit, Setter 312, which may be configured to set one or more modified states, corresponding to the modified signals, on the respective qubits. For example, Setter 312 may set various different modified states, including values of modified signals, on respective qubits, each of which determined according to Step 132-136 of FIG. 1.

In some exemplary embodiments, Circuit 302 may be generated to comprise a second sub-circuit, Inverse Transformation 313, which may be configured to inverse the transformation that was used by Classical Computation 392 to produce the modified signal. For example, a separate inverse transformer may be wired or concatenated to each modified state of a qubit. In some exemplary embodiments, Inverse Transformation 313 may output the original Signal 330 that represents the initial state. In some exemplary embodiments, the outputted Signal 330 may be provided to Sub-Circuit 320, which may manipulate Signal 330 according to a desired functionality.

FIG. 3C depicts an exemplary Circuit 303 and a Classical Computation 393. In some exemplary embodiments, Circuit 303 may comprise multiple elements that correspond to Circuit 302, such as Setter 312, Inverse Transformation 313, Signal 330, and Sub-Circuit 320.

In some exemplary embodiments, Classical Computation 393 may apply a lossy Transformation and Compression 321 on a Signal 330, to thereby obtain a modified signal that represents an approximation of the initial state. In some exemplary embodiments, the approximation may be lossy, thus not enabling to reconstruct the entire initial signal based on the modified signal. In other cases, other compressions may be used that are not lossy. In some exemplary embodiments, since the modified states of the qubits may represent an approximation of the initial state, Inverse Transformation 313 may inverse the transformation of Transformation and Compression 321, and potentially part of the compression, but may not be able to inverse the entire lossy compression that was used by Classical Computation 393. In some exemplary embodiments, instead of reconstructing the value of Signal 330, Inverse Transformation 313 may output an Approximation 340 of the Signal 330. In some exemplary embodiments, the outputted Approximation 340 may be provided to Sub-Circuit 320, which may manipulate Signal 330 according to a desired functionality. In some cases, an accuracy of an output from

In some exemplary embodiments, due to the lossy compression, Setter 312 of Circuit 303 may utilize less resources than Setter 312 of Circuit 302, and accordingly, executing Circuit 303 may utilize less resources than executing Circuit 302. It is noted, however, that in some cases, due to the lossy compression, the output from Circuit 303 may have a higher error rate, or a lower accuracy, compared to the output from Circuit 302.

FIG. 3D depicts an exemplary Circuit 304 and a Classical Computation 394. In some exemplary embodiments, Circuit 304 may comprise multiple elements that correspond to Circuit 302, such as Transformation 311, Setter 312, Inverse Transformation 313, and Signal 330. In some cases, Sub-Circuit 320 may correspond to Sub-Circuit 320A and Sub-Circuit 320B.

In some exemplary embodiments, instead of immediately inversing the modified signal, as performed in FIGS. 3B-3D, in the scenario of FIG. 3D, Inverse Transformation 313 may be delayed for one or more cycles. In some exemplary embodiments, at least a portion of Sub-Circuit 320, denoted Sub-Circuit 320A, may manipulate the modified qubit states in their modified representation. In some cases, Sub-Circuit 320A may be adjusted to enable it to manipulate the qubit state in its modified form according to a desired functionality, instead of manipulating the qubit in an initial state that corresponds to Signal 330. For example, Sub-Circuit 320A may be adjusted by adjusting a high-level representation of a quantum program that is implemented by Sub-Circuit 320A, to deal with one or more modified qubit states.

In some exemplary embodiments, after Sub-Circuit 320A manipulates the qubit states in their modified form, the states may be inversed by Inverse Transformation 313, which may be concatenated to Sub-Circuit 320A. In some exemplary embodiments, a qubit state that is outputted from Inverse Transformation 313 may correspond to Signal 330 after being manipulated by Sub-Circuit 320A, and may be provided to Sub-Circuit 320B for further manipulations. In some cases, Sub-Circuit 320B may be omitted, and Sub-Circuit 320A may comprise the entirety of Sub-Circuit 320. In some cases, Inverse Transformation 313 may be omitted, such as in case that the manipulated qubit states are not manipulated by Sub-Circuit 320A or by Sub-Circuit 320B. In such cases, Classical Computation 394 may implement Inverse Transformation 313 on the state of the qubit that is outputted from Circuit 304.

In some exemplary embodiments, the scenario of FIG. 3D may be advantageously implemented in cases that manipulating a qubit state in the modified form is more efficient, and uses less resources, compared to manipulating the qubit state in the initial form, e.g., similar to the scenario of FIG. 3E. For example, in such cases, executing Circuit 304 may utilize less resources than executing Circuit 302 or Circuit 303.

FIG. 3E depicts an exemplary scenario according to the structure of FIG. 3D. According to the scenario of FIG. 3E, Circuit 304 may be configured to manipulate multiple initial states, represented by Signals 330A-330N, by aggregating the initial states of the qubits. Signals 330A-330N may be defined over a time base. In some exemplary embodiments, each signal of Signals 330A-330N may correspond to an initial state of a qubit or qubit register.

In some exemplary embodiments, Classical Computations 331A-331N may transform Signals 330A-330N, respectively, to a range domain, a frequency domain, or the like. For example, Classical Computations 331A-331N may utilize the Fourier transformation to transform Signals 330A-330N, such as audio signals, from a time domain to a frequency domain. As another example, Classical Computations 331A-331N may utilize DCT state transfers, Hadamard transformations, or the like, to transform Signals 330A-330N. In some exemplary embodiments, Circuit 304 may be generated to comprise a Setter 312 that is configured to set the modified version of Signals 330A-330N on the respective qubits. It is noted that in some scenarios, not all the qubits of Circuit 304 may be set with a modified version of Signals 330A-330N, and some qubits may be set with an original signal of Signals 330A-330N, such as in case a transformation is not found for the initial state of the qubit.

In some exemplary embodiments, aggregating signals in the range domain may be more efficient (e.g., using less resources) than aggregating signals in the time domain, and thus, Circuit 304 may be generated to enable signal aggregation in the range domain. In some exemplary embodiments, Sub-Circuit 320, which may implement the functionality of the circuit, may be split into two portions. Sub-Circuit 320A and Sub-Circuit 320B. Sub-Circuit 320A may be configured to aggregate the signals, and Sub-Circuit 320B may comprise any remaining functionalities, such as functionalities that are not more efficient in the range domain. In some exemplary embodiments, Sub-Circuit 320A may be modified to enable it to aggregate signals in a range domain.

In some exemplary embodiments, Inverse Transformation 313 may be delayed. In some exemplary embodiments, Circuit 304 may be generated to comprise Inverse Transformation 313 after the signal aggregation, thus enabling to aggregate Signals 330A-330N in the range domain, and enabling further manipulations in the time domain. In some exemplary embodiments, the state of the qubits that are outputted from Sub-Circuit 320A, including an aggregation of Signals 330A-330N in the range domain, may then be inversed by Inverse Transformation 313, to thereby obtain the aggregation of Signals 330A-330N in the original time domain. In some exemplary embodiments, the result of the aggregation of Signals 330A-330N may be provided to Sub-Circuit 320B in the time domain, for any further manipulations.

It is noted that Sub-Circuit 320A comprises a modified portion of Circuit 304, and Sub-Circuit 320B may comprise a non-modified portion of Circuit 304.

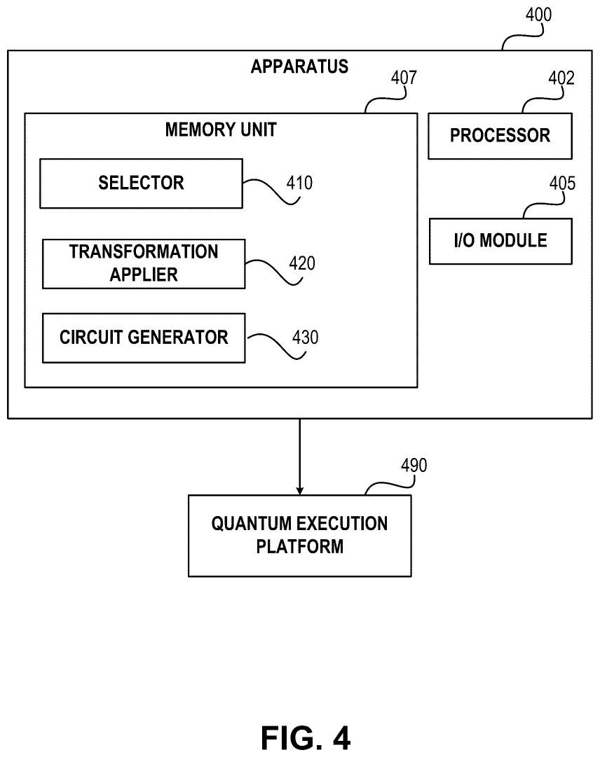

Referring now to FIG. 4 showing a block diagram of an apparatus, in accordance with some exemplary embodiments of the disclosed subject matter.

In some exemplary embodiments. Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 400 or any of its subcomponents. It is noted that Processor 402 may be a traditional classical processor, and not necessarily a quantum processor.

In some exemplary embodiments of the disclosed subject matter, Apparatus 400 may comprise an Input/Output (I/O) module 405. I/O Module 405 may be utilized to provide an output to and receive input from a user, an apparatus, or the like, such as, for example to obtain a user-defined accuracy requirement for quantum states, to obtain an indication of a quantum circuit, to obtain an indication of initial states for qubits of the quantum circuit, or the like.

In some exemplary embodiments, Apparatus 400 may comprise Memory 407. Memory 407 may be a hard disk drive, a Flash disk, a Random Access Memory (RAM), a memory chip, or the like. In some exemplary embodiments, Memory 407 may retain program code operative to cause Processor 402 to perform acts associated with any of the subcomponents of Apparatus 400. Memory 407 may comprise one or more components as detailed below, implemented as executables, libraries, static libraries, functions, or any other executable components.

In some exemplary embodiments, Memory 407 may comprise one or more components, such as a Selector 410, which may be configured to select one or more transformations for respective initial quantum states, e.g., according to Step 132 of FIG. 1. For example, Selector 410 may calculate a resource score for each combination of transformation and initial state, and select transformations that utilize the least amount of resource.

In some exemplary embodiments, Memory 407 may comprise a Transformation Applier 420, which may utilize any selected transformation from Selector 410 to transform the respective initial state to a modified state that represents the initial state in a scarce, diluted, manner. Transformation Applier 420 may or may not compress the modified state.

In some exemplary embodiments, Memory 407 may comprise a Circuit Generator 430, which may be configured to obtain from Transformation Applier 420 one or more modified states that are associated to respective qubits, and generate a modified circuit that is configured to set or prepare the modified state on the respective qubits. For example, Circuit Generator 430 may inject in the modified circuit one or more setters that are configured to produce the modified state.

In some exemplary embodiments, Circuit Generator 430 may further include, in the modified circuit, an inverse transformation that is configured to inverse the transformation of each modified state. For example, the modified circuit may be generated to comprise a sub-circuit that includes an inverse matrix of the transformation matrix that is concatenated to the modified states, thereby reconstructing the initial states. In some cases, instead of concatenating the inverse transformation to the modified states, the inverse transformation may be delayed in one or more cycles. In some exemplary embodiments, the resulting modified circuit may be executed or simulated on a Quantum Execution Platform 490.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an extremal computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
computing, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits; and
generating a modified quantum circuit based on the quantum circuit, the modified quantum circuit is configured to be executed by a quantum computer, the modified quantum circuit comprising the one or more qubits,
wherein the modified quantum circuit excludes the original sub-circuit,
wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.

2. The method of claim 1, wherein said computing the modified quantum state comprises:
applying the transformation on the initial quantum state, to thereby obtain a transformed quantum state; and
compressing the transformed quantum state to obtain the modified quantum state.

3. The method of claim 2, wherein the transformed quantum state is represented by a set of coefficients in a state base, said compressing comprises removing one or more coefficients from the set of coefficients, whereby the inverse transformation enables to provide a partial reconstruction of the initial quantum state and not a full reconstruction of the initial quantum state.

4. The method of claim 3, wherein the one or more coefficients are selected to be removed by said compressing based on a determination that the one or more coefficients are insignificant.

5. The method of claim 1 further comprising selecting the transformation from a set of potential transformations, wherein said selecting is performed based on at least one of:
a first amount of quantum resources required for setting the modified quantum state on the one or more qubits; and
a second amount of quantum resources required for applying the inverse transformation on the one or more qubits at one or more subsequent cycles of the modified quantum circuit.

6. The method of claim 1, wherein execution of the quantum circuit utilizes a quantum resource, wherein execution of the modified quantum circuit does not utilize the quantum resource.

7. The method of claim 1, wherein said generating the modified quantum circuit comprises setting the modified quantum state on the one or more qubits using one or more quantum state setters.

8. The method of claim 1, wherein the modified quantum state comprises a scarce representation of the initial quantum state.

9. The method of claim 8, wherein the initial quantum state is represented by a first set of coefficients over a first state base, and the scarce representation utilizes a second set of coefficients over a second state base, wherein the first set of coefficients comprises a greater number of coefficients than the second set of coefficients.

10. The method of claim 1 further comprises executing, by the quantum computer, the modified quantum circuit.

11. The method of claim 1 further comprises determining the initial quantum state, wherein the initial quantum state is determined by executing the quantum circuit or a representation thereof.

12. An apparatus comprising a processor and coupled memory, said processor being adapted to:
compute, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits; and
generate a modified quantum circuit based on the quantum circuit, the modified quantum circuit is configured to be executed by a quantum computer, the modified quantum circuit comprising the one or more qubits,
wherein the modified quantum circuit excludes the original sub-circuit,
wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.

13. The apparatus of claim 12, wherein said computing the modified quantum state comprises:
applying the transformation on the initial quantum state, to thereby obtain a transformed quantum state; and
compressing the transformed quantum state to obtain the modified quantum state.

14. The apparatus of claim 13, wherein the transformed quantum state is represented by a set of coefficients in a state base, said compressing comprises removing one or more coefficients from the set of coefficients, whereby the inverse transformation enables to provide a partial reconstruction of the initial quantum state and not a full reconstruction of the initial quantum state.

15. The apparatus of claim 12 further comprising selecting the transformation from a set of potential transformations, wherein said selecting is performed based on at least one of:
a first amount of quantum resources required for setting the modified quantum state on the one or more qubits; and
a second amount of quantum resources required for applying the inverse transformation on the one or more qubits at one or more subsequent cycles of the modified quantum circuit.

16. The apparatus of claim 12, wherein execution of the quantum circuit utilizes a quantum resource, wherein execution of the modified quantum circuit does not utilize the quantum resource.

17. The apparatus of claim 12, wherein the modified quantum state comprises a scarce representation of the initial quantum state, wherein the initial quantum state is represented by a first set of coefficients over a first state base, and the scarce representation utilizes a second set of coefficients over a second state base, wherein the first set of coefficients comprises a greater number of coefficients than the second set of coefficients.

18. The apparatus of claim 12 further comprises executing, by the quantum computer, the modified quantum circuit.

19. The apparatus of claim 12 further comprises determining the initial quantum state, wherein the initial quantum state is determined by executing the quantum circuit or a representation thereof.

20. A computer program product comprising a non-transitory computer readable medium retaining program instructions, which program instructions when read by a processor, cause the processor to:
compute, using a classical computer, a modified quantum state, the modified quantum state is computed based on an application of a transformation on an initial quantum state, the initial quantum state is associated with one or more qubits, a quantum circuit comprising the one or more qubits and an original sub-circuit that is configured to set the initial quantum state on the one or more qubits; and
generate a modified quantum circuit based on the quantum circuit, the modified quantum circuit is configured to be executed by a quantum computer, the modified quantum circuit comprising the one or more qubits,
wherein the modified quantum circuit excludes the original sub-circuit,
wherein the modified quantum circuit comprises a modified sub-circuit, the modified sub-circuit is configured to set the modified quantum state on the one or more qubits of the modified quantum circuit during one or more cycles of the modified quantum circuit, wherein the modified sub-circuit is configured to apply an inverse transformation on the modified quantum state of the one or more qubits at one or more subsequent cycles of the modified quantum circuit, the one or more subsequent cycles of the modified quantum circuit are subsequent to the one or more cycles, the inverse transformation is configured to inverse the transformation, whereby an application of the inverse transformation in the modified quantum circuit is configured to restore the initial quantum state or an approximation thereof.
